(19) United States
(12) Patent Application Publication
(10) Pub. No.: US 2021/0106145 A1
(43) Pub. Date: Apr. 15, 2021

(54) MEDICAL FURNITURE COVER AND METHOD OF APPLYING THE SAME

(71) Applicants: MEDFIRE INNOVATIONS INC., San Diego, CA (US); MAGNIANT, LLC, Carlsbad, CA (US)

(72) Inventors: Gregory Christmas, San Diego, CA (US); Robert Crousore, Athol, ID (US)

(21) Appl. No.: 16/740,250

(22) Filed: Jan. 10, 2020

Related U.S. Application Data
(63) Continuation-in-part of application No. 29/709,414, filed on Oct. 14, 2019.

(51) Int. Cl. A47C 31/10; A61G 7/05

(52) U.S. Cl. CPC A47C 31/105; A61G 7/0506; A61G 7/0507

(57) ABSTRACT

The medical furniture cover includes a plurality of surfaces being formed of a thermoplastic material, the plurality of surfaces including an upper surface and a plurality of side surfaces integral with and extending from the upper surface, the upper and side surfaces being configured to cover corresponding surfaces of a medical furniture. The upper surface is sized to fit the length and the width of the medical furniture, and the cover has an opening opposite the upper surface for fitting the cover over the medical furniture. A periphery of the opening is formed by distal ends of the side surfaces, and an elastic band is attached to the cover and extends along the periphery of the opening for securing the cover to the medical furniture.

### CROSS-REFERENCE TO RELATED APPLICATION

This application is a continuation-in-part of U.S. Design patent application Ser. No. 29/709,414 (“HOSPITAL BED COVER”), filed on Oct. 14, 2019, the entire content of which is incorporated herein by reference.

### BACKGROUND

### 1. Field

Aspects of embodiments of the present invention are directed toward a medical furniture cover and a method for applying the cover to medical furniture.

### 2. Description of Related Art

Covers (e.g., protective covers) are sometimes used by medical personnel to temporarily cover specific high-touch surface areas of medical furniture, such as hospital beds or gurneys. For example, a cover may be placed over a specific part of the hospital bed or gurney, such as a head board, a side rail (e.g., a side arm), a foot board, or a mattress (e.g., areas that are subject to regular and/or repeated human contact). The use of such covers can help avoid the overapplication of cleaning agents and reduce the need for anti-bacterial products.

Because medical furniture is often used by hospital patients, such as how hospital beds or gurneys are often used to support and transport patients undergoing medical treatment for illnesses (e.g., caused by bacterial or viral infections) or for traumatic injuries (e.g., from car accidents or surgery), a patient may excrete bodily fluids onto the medical furniture, such as blood, vomit, feces, urine, saliva, and the like. After use, the medical furniture must be cleaned and sterilized to remove the bodily fluids and make it safe for another patient and the medical personnel. Furthermore, a clean bed may become contaminated with potentially dangerous organisms after being touched by anyone who has not washed their hands first. Ensuring the medical furniture is cleaned and sterilized reduces the probability that medical personnel, a subsequent patient, or passersby will be exposed to any bodily fluids, germs, and/or bacteria present on the medical furniture.

### SUMMARY

Aspects of embodiments of the present invention are directed toward a medical furniture cover and a method of using the same.

One embodiment of the present invention provides a medical furniture cover including: a plurality of surfaces being formed of a thermoplastic material, the plurality of surfaces including an upper surface and a plurality of side surfaces integral with and extending from the upper surface. The upper and side surfaces are configured to cover corresponding surfaces of a medical furniture. Two of the side surfaces are sized to fit a width and a height of the medical furniture, two others of the side surfaces are sized to fit a length and the height of the medical furniture, and the upper surface is sized to fit the length and the width of the medical furniture. The cover has an opening opposite the upper surface for fitting the cover over the medical furniture, a periphery of the opening is formed by distal ends of the side surfaces, and an elastic band is attached to the cover and extends along the periphery of the opening for securing the cover to the medical furniture.

The medical furniture may be a hospital bed or a gurney.

The thermoplastic material may include polyethylene.

The thermoplastic material may include chlorinated polyethylene.

The cover may have a thickness between 2 mils and 5 mils.

The cover may include a plurality of grommet holes fitted with grommets for securing the cover to the medical furniture.

The cover may include a plurality of gussets to form a squared profile for securing the cover to the medical furniture.

The cover may include a color from among a color-coding scheme, wherein the color-coding scheme includes at least two colors.

At least a portion of a surface from among the plurality of surfaces of the cover may be transparent to allow a user to see a medical furniture control.

At least one side surface of the cover may be sized to allow a user to access a medical furniture control without removing the cover.

Two of the side surfaces of the cover may be substantially the same size.

Two other side surfaces of the cover may be substantially the same size.

The cover may be infused with an antimicrobial additive solution.

Another embodiment of the present invention provides a cover and hospital bed (or gurney) system including: a hospital bed (or gurney) including a superstructure and an undercarriage supporting the superstructure, the superstructure having a length, a width, and a height; and a cover having an upper surface, a plurality of side surfaces integral with and extending from the upper surface, and an opening opposite the upper surface, a periphery of the opening being formed by distal ends of the side surfaces. The cover includes an elastic band extending along the periphery of the opening. The cover has a length and a width greater than the length and the width of the superstructure such that the cover fits entirely around an upper and side surfaces of the superstructure.

The superstructure may include a deck, a mattress, a foot board, a head board, a plurality of side rails, and controls.

A length and a width of the cover may be respectively greater than a length and a width of the deck.

A height of the cover may be greater than a highest structure from the foot board, the head board, and the plurality of side rails such that the undercarriage extends through the opening in the cover.

The periphery of the opening may not extend beyond a bottom edge of the superstructure.

The cover may be formed of a thermoplastic material.

Another embodiment of the present invention provides a method of covering a medical furniture with a cover having an upper surface, a plurality of side surfaces integral with and extending from the upper surface, and an opening opposite the upper surface, a periphery of the opening formed by distal ends of the side surfaces. The method includes: applying a portion of the periphery of the opening closest to one of the side surfaces of the cover around a portion of the medical furniture; spreading the one of the side surfaces of the cover over the medical furniture; spreading the upper surface and other ones of the side surfaces of the cover over a remainder of the medical furniture; and securing an entirety of the periphery of the opening around a perimeter of the medical furniture.

### BRIEF DESCRIPTION OF THE DRAWINGS

The above and other features and aspects of the present invention will become more apparent by describing, in detail, example embodiments thereof with reference to the attached drawings, in which:

FIG. 1 is a perspective view of a hospital bed and cover according to an embodiment of the present invention;

FIG. 2 is a front view of the hospital bed and cover;

FIG. 3 is a rear view of the hospital bed and cover;

FIG. 4 is a left-side view of the hospital bed and cover;

FIG. 5 is a right-side view of the hospital bed and cover;

FIG. 6 is a top view of the hospital bed and cover;

FIG. 7 is a bottom view of the hospital bed and cover;

FIG. 8A is a perspective view of a hospital bed and cover according to another embodiment of the present invention; FIG. 8B is a bottom view of the hospital bed and cover according the embodiment of FIG. 8A; FIG. 8C is a bottom view of the hospital bed and cover according to another version of the embodiment of FIG. 8A;

FIG. 9 is a perspective view of a hospital bed and cover according to another embodiment of the present invention;

FIG. 10 is a method of covering a hospital bed with a cover according to an embodiment of the present invention.

FIG. 11 is a method of covering a hospital bed with a cover according to another embodiment of the present invention.

FIGS. 12A-12C illustrate a method of removing and disposing of a cover according to an embodiment of the present invention.

### DETAILED DESCRIPTION

The present invention will now be described more fully with reference to the accompanying drawings in which example embodiments of the invention are shown. Like reference numerals in the figures denote like elements throughout and redundant descriptions thereof may be omitted.

It will be understood that when an element is referred to as being “on,” “connected to,” or “coupled to” another element, it may be directly on, connected, or coupled to the other element or one or more intervening elements may also be present. When an element is referred to as being “directly on,” “directly connected to,” or “directly coupled to” another element, there are no intervening elements present. As used herein, the term “and/or” includes any and all combinations of one or more of the associated listed items. Furthermore, the use of “may” when describing embodiments of the present invention relates to “one or more embodiments of the present invention.”

Spatially relative terms, such as “beneath,” “below,” “lower,” “above,” “upper,” “bottom,” “top” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

As used herein, the term “substantially” refers to normal variations that occur due to, for example, manufacturing tolerances. Furthermore, the terminology used herein is for the purpose of describing particular example embodiments only and is not intended to limit the example embodiments described herein. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

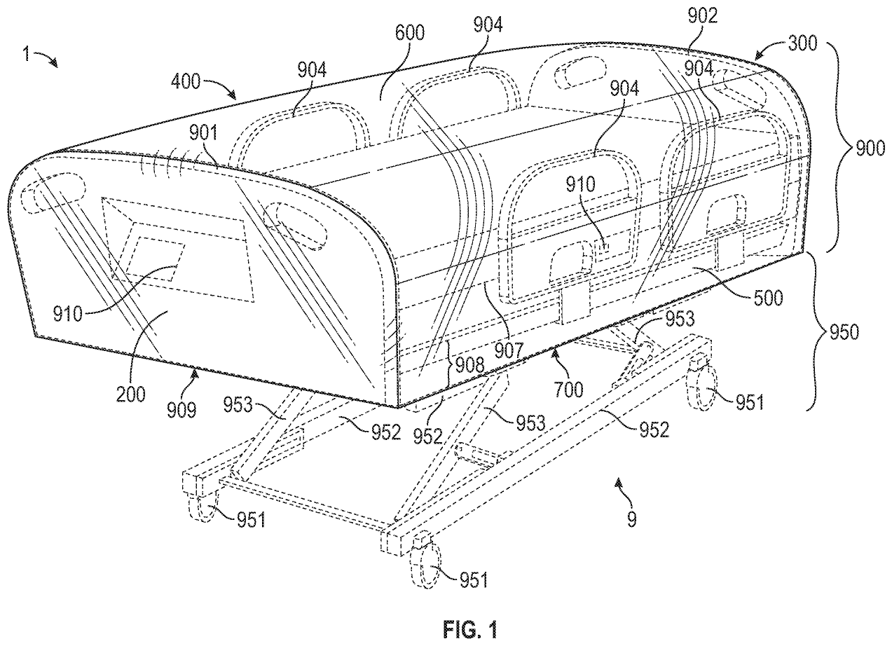

With reference to FIGS. 1-7, a medical furniture cover (e.g., a hospital bed cover or gurney cover, referred to throughout this specification as a “cover”) 1 according to an embodiment of the present invention may have approximately a rectangular shape, when in use, with several continuously interrelated (e.g., interconnected or integrated) surfaces. That is, in some embodiments, a surface may not have a readily identifiable beginning or ending where an adjacent surface begins or ends. Rather, each surface may be more identifiable by referring to the corresponding parts (e.g., components, structures, sections or surfaces) of the underlying medical furniture covered when the cover is in use.

Accordingly, structures of a typical hospital bed 9 (hereinafter, a “hospital bed,” “bed,” or “gurney”), which is one example of medical furniture as would be understood by one skilled in the art, will be identified to further describe aspects of embodiments of the present invention. A typical hospital bed may include a superstructure 900 and an undercarriage 950. The superstructure 900 includes many of the structures of the bed that are highly likely to come into contact with contaminants, as well as medical personnel, patients, passersby, or other neighboring structures (e.g., other hospital beds, gurneys, walls, chairs, or dividers). For example, the superstructure 900 may include a foot board 901, a head board 902, a side rail (e.g., a side arm) 904, a mattress 907, a deck 908, and an undersurface (e.g., an underside) 909. Furthermore, the undersurface 909 may include a plurality of surfaces from other parts, components, or structures connected thereto. Furthermore, one or more of the superstructure 900 surfaces may be fitted with electronic or mechanical controls (hereinafter, “controls”) 910. The undercarriage 950 may include many of the parts, components, or structures of the bed that are typically designed to provide support, stability, adjustability, and transportability for the hospital bed or gurney. For example, the undercarriage may include casters 951, frame members 952, and adjustment members 953.

The cover 1, according to one embodiment, may have a plurality of surfaces (e.g., five or six surfaces) including an upper surface and four side surfaces extending distally from the upper surface. The plurality of surfaces may be more readily identifiable when the cover is in use, and may include: a front (e.g., a first side) surface 200, a rear (e.g., a second side) surface 300, a left-side (e.g., a third side) surface 400, a right-side (e.g., a fourth side) surface 500, a top (e.g., an upper) surface 600, and a bottom surface 700 (e.g., an area of the cover comprising an opening in the cover, opposite the upper surface of the cover, for fitting the cover over medical furniture). When in use, the top surface 600 is positioned substantially parallel with and opposite to the bottom surface 700. When in use, the top and bottom surfaces 600 and 700 extend along a length and width direction of the covered superstructure 900. That is, the cover 1 has a length and width defined by (e.g., sufficient to cover) the top and bottom surfaces 600 and 700 while the cover 1 is being used to cover a superstructure 900 of a hospital bed (or gurney) 9. When in use, the front surface 200 is positioned substantially parallel with and opposite to the rear surface 300. When in use, the front and rear surfaces 200 and 300 extend along a height and width direction of the covered superstructure 900. That is, the cover 1 has a height and width defined by (e.g., sufficient to cover) the front and rear surfaces 200 and 300 while the cover 1 covers a superstructure 900 of a hospital bed (or gurney) 9. When in use, the left-side surface 400 is positioned substantially parallel with and opposite to the right-side surface 500. When in use, the left-side and right-side surfaces 400 and 500 extend along a height and length direction of the covered superstructure 900. That is, the cover 1 has a height and length defined by (e.g., sufficient to cover) the left-side and right-side surfaces 400 and 500 while the cover is covering a superstructure 900 of a hospital bed (or gurney) 9.

The cover 1 is sized to be larger (e.g., slightly larger) than a typical hospital bed (or gurney) superstructure 900. However, the cover 1 is not limited thereto and may be suitably sized to fit other medical furniture. For example, the cover 1 may be about 94 inches long, about 45 inches wide, and about 20 inches high. However, the present invention is not limited thereto, and the cover 1 may have a length (e.g., a minimum length), width (e.g., a minimum width) and height (e.g., a minimum height) as follows. The cover 1 may have a length that is at least as long as a combination of the length of the deck 908 and the thicknesses of the foot board 901 and the head board 902 (e.g., to the extent that the foot board 901 and head board 902 add length to the bed 9 beyond the length of the deck 908). The cover 1 may have a width that is at least as wide as a combination of the width of the deck 908 and the thicknesses of both a side rail 904 on the left side of the bed and a side rail 904 on the right side of the bed (e.g., to the extent that the side rails 904 add width to the bed 9 beyond the width of the deck 908). Finally, the cover 1 may have a height that is at least as high as the highest structure from the foot board 901, the head board 902, and a side rail 904 as measured from the undersurface 909 of the superstructure 900 to the top-most surface of the respective structure from the foot board 901, the head board 902, and a side rail 904.

Because the entire high-touch surface area of the superstructure 900 of the bed 9 is covered by the cover 1, the cover 1 reduces the potential spread of contaminants (e.g., harmful pathogens and bacteria) by providing a barrier between many structures of the bed that are highly likely to come into contact with contaminants and the hospital environment. Furthermore, the life of the medical furniture may be extended because the cover 1 protects the medical furniture from the hospital environment.

To improve operational efficiencies (e.g., the time and effort required for hospital personnel to prepare medical furniture for use by a patient) and to further reduce the risk of cross-contamination and contamination of passersby, the cover 1 may be provided in an assortment of colors (e.g., color-coded, a color-coding scheme) to allow users to identify and communicate the condition of a particular hospital bed 9. For example, a clean (e.g., a disinfected or decontaminated) bed 9 may be fitted with a green cover 1; a soiled (e.g., a contaminated or used) bed 9 may be fitted with a red cover 1; and a bed 9 having a condition of which the user is uncertain may be fitted with a clear (e.g., an uncolored or neutral colored) cover 1.

The overall dimensions of the superstructure 900 (e.g., the height, the width, the length, and the thickness of the superstructure 900) are not substantially increased when the cover 1 is used to cover the superstructure 900. Because the dimensions of the superstructure 900 are not substantially increased when the cover 1 is covering the superstructure 900, the hospital bed or gurney 9 may be allocated for cleaning by hospital personnel or allocated for reuse by subsequent patients after cleaning, in the same way as the hospital bed or gurney 9 would be allocated without the cover 1 covering the superstructure 900.

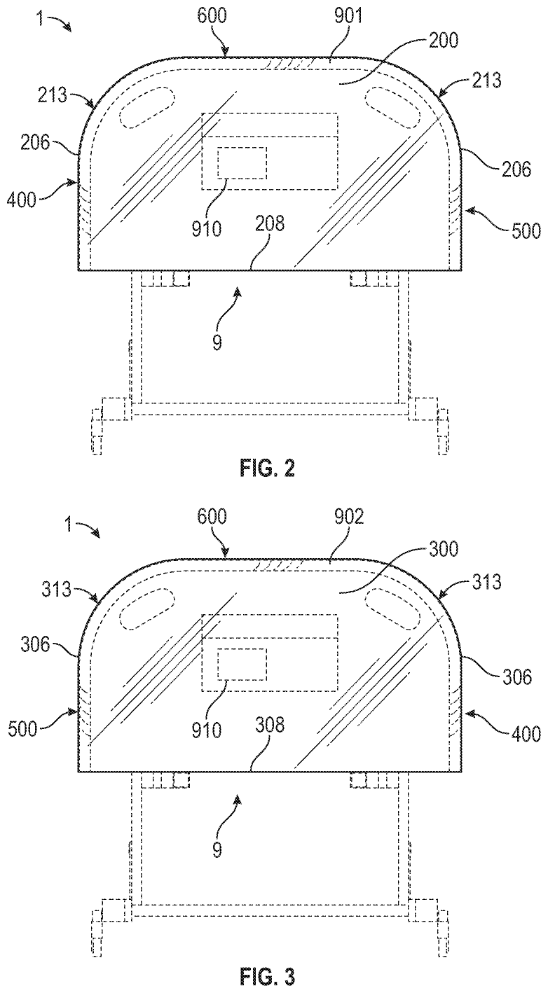

With reference to FIG. 2, a front surface 200 of the cover 1 may have approximately a rectangular shape with rounded top corners 213, when in use. For example, a bottom edge 208 of the front surface 200 may conform to the shape of a foot board 901 having a substantially flat bottom edge and rounded top corners. However, the shape of the cover 1, when in use, is not limited thereto and may be suitably sized and suitably shaped to fit other foot board styles.

To allow a user to see objects within the hospital bed 9 and to allow for user access and use of controls 910 mounted to or housed within the foot board 901, the front surface 200 may be made of a thin plastic material (e.g. a material including plastic alone or a combination of plastic and fiber). For example, any portion of the cover 1 may be made of a thermoplastic (e.g., formed of a material including thermoplastic), such as Chlorinated Polyethylene (“CPE”), and may have a thickness ranging from about 2 mil to about 4 mil (e.g., from about 0.002 inches to about 0.004 inches). CPE has desirable characteristics, including resistance to heat and oxidation, good anti-aging properties, excellent weatherability, anti-combustion, no self-ignition, good low-temperature flexibility, good endurance to chemicals, good processing ability, good stability, fluid resistant (e.g., impermeable), low environmental impact, and it may be easily shaped. The plastic material may have transparent qualities (e.g., translucent characteristics) that allow a user to see the controls 910, and the front surface 200 may be suitably sized and suitably shaped for sufficient slack (e.g., a relaxed fit) that allows a user to use the controls 910 without removing the cover 1. To more closely match different shapes of foot boards and to have a tighter or looser fit over different superstructures, the cover 1 may be made (e.g., manufactured, fitted, shaped, modified, or tailored) with different gussets 206, near where the front surface 200 and left-side surface 400 meet, and near where the front surface 200 and right-side surface 500 meet.

With reference to FIG. 3, a rear surface 300 of the cover 1 may have approximately a rectangular shape with rounded top corners 313, when in use. For example, a bottom edge 308 of the rear surface 300 may conform to the shape of a head board 902 having a substantially flat bottom edge and rounded top corners. However, the shape of the cover 1, when in use, is not limited thereto and may be suitably sized and suitably shaped to fit other head board styles.

To allow a user to see objects within the hospital bed 9 and to allow for user access and use of controls 910 mounted to or housed within the head board 902, the rear surface 300 may be made of a thin plastic material having transparent qualities (e.g., translucent characteristics) that allow a user to see the controls 910, and the rear surface 300 may be suitably sized and suitably shaped for sufficient slack (e.g., a relaxed fit) that allows a user to use the controls 910 without removing the cover 1. To more closely match different shapes of head boards and to have a tighter or looser fit over different superstructures, the cover 1 may be made with different gussets 306, near where the rear surface 300 and left-side surface 400 meet, and near where the rear surface 300 and right-side surface 500 meet.

In some embodiments, to be easier to install over the medical furniture, the front and rear surfaces 200 and 300 of the cover 1 may be identical (or substantially the same), such that the cover 1 does not have different front and rear surfaces. This way, a user can quickly and easily install the cover 1 over the medical furniture without having to confirm the orientation of the cover 1 prior to installing it over the medical furniture.

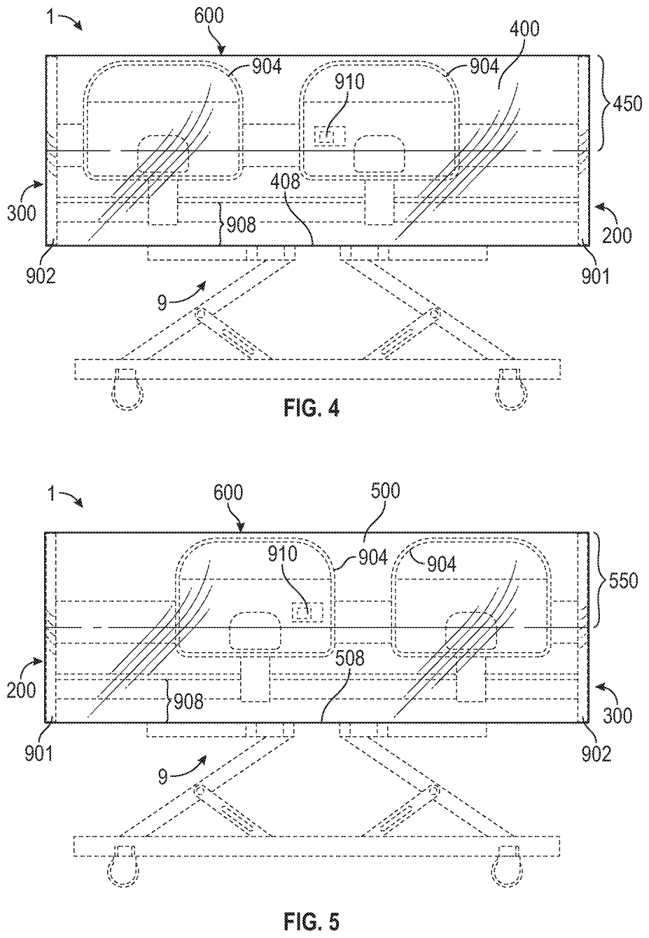

With reference to FIG. 4, a left-side surface 400 of the cover 1 may have approximately a rectangular shape with rounding off of a left-side top portion 450, when in use. For example, a bottom edge 408 of the left-side surface 400 may conform to the shape of a foot board 901, a head board 902, and a deck 908 having substantially flat bottom edges, while the left-side top portion 450 may round inward towards the top surface 600. Furthermore, the left-side top portion 450 may conform to the shape of a side rail 904 where the left-side top portion 450 rounds inward towards the top surface 600. However, the shape of the cover 1, when in use, is not limited thereto and may be suitably sized and suitably shaped to fit other foot board, head board, deck and side rail styles.

To allow a user to see objects within the hospital bed 9 and to allow for user access and use of controls 910 mounted to or housed within a side rail 904, the left-side surface 400 may be made of a thin plastic material having transparent qualities (e.g., translucent characteristics) that allow a user to see the controls 910, and the left-side surface 400 may be suitably sized and suitably shaped for sufficient slack (e.g., a relaxed fit) that allows a user to use the controls 910 without removing the cover 1.

With reference to FIG. 5, a right-side surface 500 of the cover 1 may have approximately a rectangular shape with rounding off of a right-side top portion 550, when in use. For example, a bottom edge 508 of the right-side surface 500 may conform to the shape of a foot board 901, a head board 902, and a deck 908 having substantially flat bottom edges, while the right-side top portion 550 may round inward towards the top surface 600. Furthermore, the right-side top portion 550 may conform to the shape of a side rail 904 where the right-side top portion 550 rounds inward towards the top surface 600. However, the shape of the cover 1, when in use, is not limited thereto and may be suitably sized and suitably shaped to fit other foot board, head board, deck and side rail styles.

To allow a user to see objects within the hospital bed 9 and to allow for user access and use of controls 910 mounted to or housed within a side rail 904, the right-side surface 500 may be made of a thin plastic material having transparent qualities (e.g., translucent characteristics) that allow a user to see the controls 910, and the right-side surface 500 may be suitably sized and suitably shaped for sufficient slack (e.g., a relaxed fit) that allows a user to use controls 910 without removing the cover 1.

In some embodiments, to be easier to install over the medical furniture, the left-side and right-side surfaces 400 and 500 of the cover 1 may be identical (or substantially the same), such that the cover 1 does not have different left-side and right-side surfaces. This way, a user can quickly and easily install the cover 1 over the medical furniture without having to confirm the orientation of the cover 1 prior to installing it over the medical furniture.

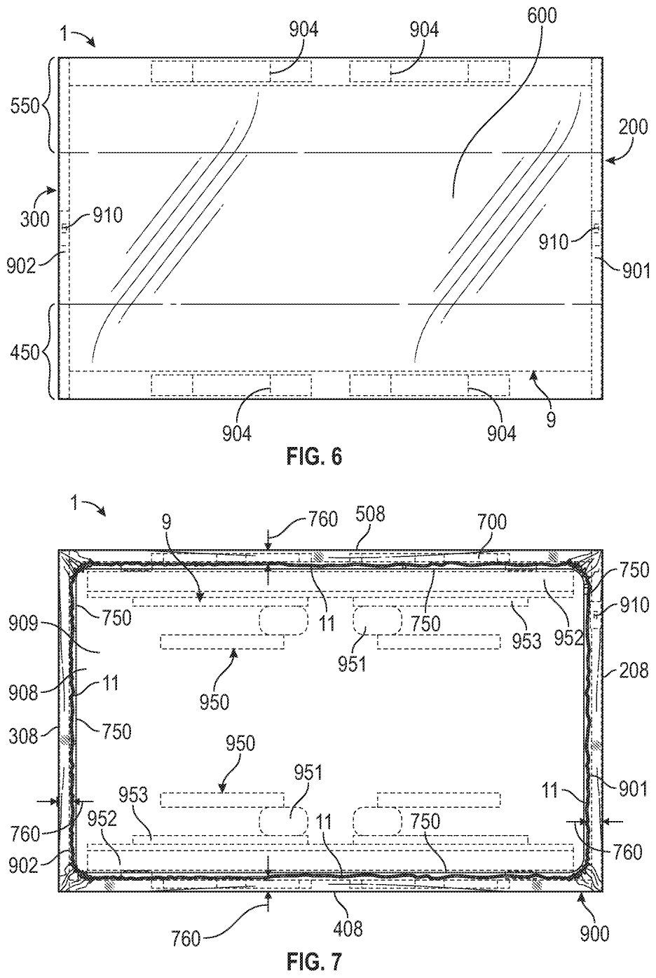

With reference to FIG. 6, a top surface 600 of the cover 1 may have approximately a rectangular shape with rounding off into the left-side top portion 450 and the right-side top portion 550, when in use. For example, the top surface 600 may conform to the shape of a foot board 901, a head board 902. Furthermore, the top surface 600 may conform indirectly to the shape of one or more side rails 904 through the left-side top portion 450 and/or the right-side top portion 550.

To allow a user to see objects within the hospital bed 9 and to allow for user access and use of controls 910 mounted to or housed within the foot board 901 or the head board 902, the top surface 600 may be made of a thin plastic material having transparent qualities (e.g., translucent characteristics) that allow a user to see the controls 910, and the top surface 600 may be suitably sized and suitably shaped for sufficient slack (e.g., a relaxed fit) that allows a user to use the controls 910 without removing the cover 1.

With reference to FIG. 7, a bottom surface 700 of the cover 1 may have approximately a rectangular shape conforming to the shape of an undersurface 909 of the hospital bed 9. The undersurface 909 may include a plurality of surfaces from other parts, components, or structures connected thereto. For example, the shape of the bottom surface 700 may conform to the shape of a combination of undersides of a foot board 901, a head board 902, a deck 908, and structures from the undercarriage 950 connected to the undersurface 909 (e.g., frame members 952 or adjustment members 953).

The bottom surface 700 may have an opening 750 defined by an area of the undersurface 909 that is left uncovered by the cover 1. Accordingly, the bottom surface 700 may have a rim (e.g., a periphery of the opening 750 that is formed by the distal ends of the four side surfaces 200, 300, 400, and 500) 760 defined by the material of the cover extending toward or beyond the bottom edges of the superstructure 900 (e.g., the edges of the superstructure corresponding to the bottom edges 208, 308, 408, and 508 of the cover) and to the opening 750. To secure (e.g., to fasten, fix, cause to stay in place, or attach) the cover 1 to the superstructure 900, an elastic band (e.g., a cord or a string) 11 may be applied to (e.g., sewn into, fitted to, inserted through, or attached to) the rim 760 near and around the perimeter of the opening 750. Because the elastic band provides a slight tension (e.g., a gripping, grappling, or clinging) around (e.g., near) the bottom edges of the superstructure 900, the cover 1 does not interfere with the casters 951 and/or adjustment members 953 of the undercarriage 950 and the bed 9 remains mobile and adjustable while covered. Furthermore, liquid spilled onto the outer surfaces of the cover, when the cover is in use, will be more likely to roll off of the cover.

To allow a user to see objects on the undersurface 909 and to allow for user access and use of controls 910 mounted to or housed within the undersurface 909, the bottom surface 700 may be made of a thin plastic material having transparent qualities (e.g., translucent characteristics) that allow a user to see the controls 910, and the bottom surface 700 may be suitably sized and suitably shaped for sufficient slack (e.g., a relaxed fit) that allows a user to use the controls 910 without removing the cover 1.

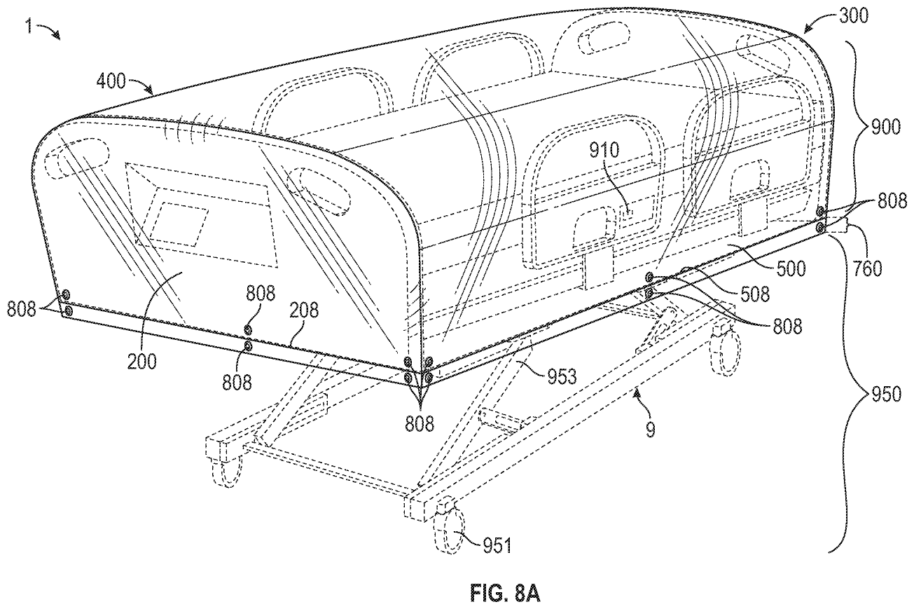

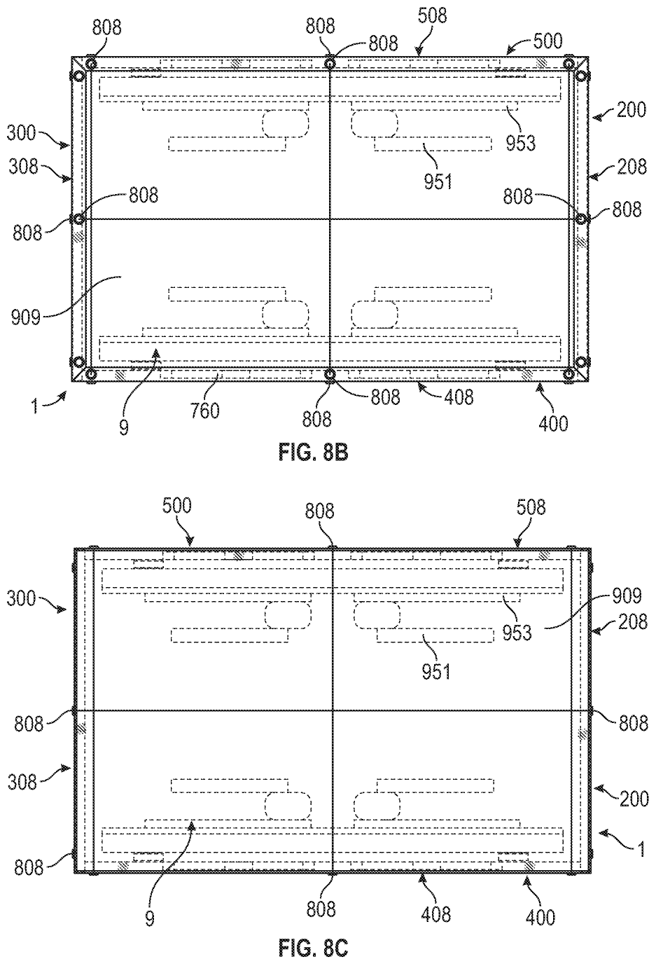

Referring to FIGS. 8A-8C, in another embodiment, the cover 1 may be secured to the superstructure 900 by using grommet holes fitted with grommets 808 instead of (or in addition to) an elastic band. For example, the cover 1 may be fitted with grommet holes fitted with grommets 808 near the sides and corners of the cover 1 along and near the bottom edges 208, 308, 408, and 508. Referring to FIGS. 8B-8C, the grommet holes fitted with grommets 808 may allow a user to secure connections (e.g., with bands, cords, or ropes) through and/or across the grommet holes fitted with grommets 808 to customize the tightness of the fit between the cover 1 and the hospital bed 9. Referring to FIGS. 8A-8B, in some embodiments, the cover 1 may have grommet holes fitted with grommets 808 fitted near and around the rim 760. Referring to FIG. 8C, in some embodiments, the rim 760 may not extend beyond the bottom edges of the superstructure 900. Nevertheless, connections may still be made between grommet holes fitted with grommets 808 near the bottom edges 208, 308, 408, and 508 on surfaces 200, 300, 400, and 500 of the cover 1.

In one embodiment, the cover 1 may be secured to the superstructure 900 by using a heavier weighted material instead of (or in addition to) an elastic band, the heavier material allowing the cover 1 to hang freely but securely by its own weight. For example, a heavier weighted material may be made of a thermoplastic, such as CPE, and may have a thickness ranging from about 3 mil to about 5 mil (e.g., from about 0.003 inches to about 0.005 inches). In some embodiments, a weight (e.g., a bean bag, etc.) may be fused into the lower edges of the cover 1. Furthermore, in some embodiments, a length of the rim 760 may be made short enough so as not to interfere with the casters 951 and/or adjustment members 953 of the undercarriage 950 so that the bed 9 remains mobile and adjustable while covered.

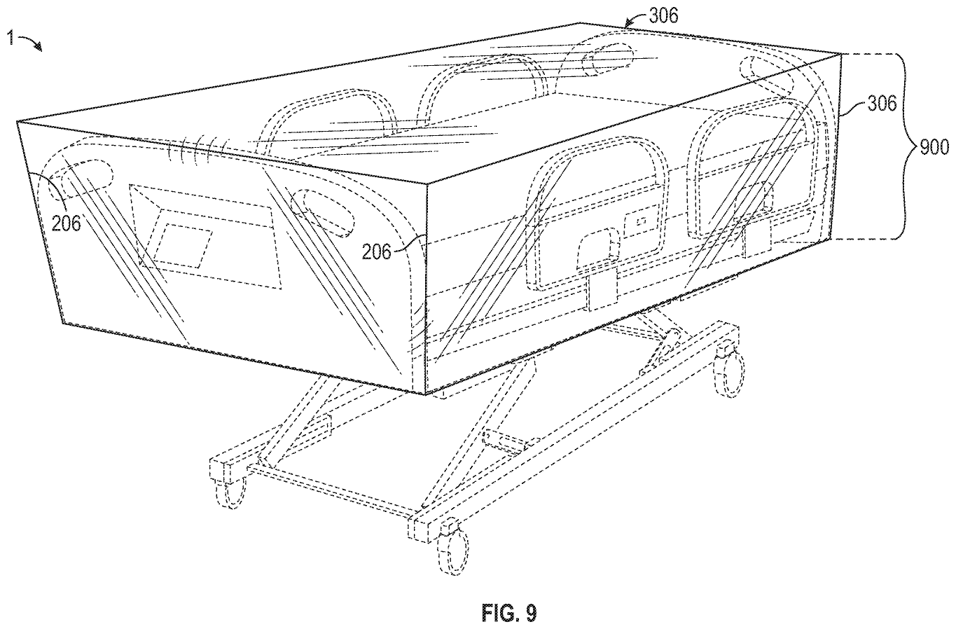

Referring to FIG. 9, in one embodiment, the cover 1 may be secured to the superstructure 900 by using more squared gussets 206 and 306 instead of (or in addition to) an elastic band. For example, the gussets 206 and 306 may be designed with a more squared profile (e.g., an outline) to allow the cover 1 to grip the shape of the superstructure 900 more tightly.

In one embodiment, the cover 1 may be infused with an antimicrobial additive solution (e.g., embedded antimicrobials) during the manufacturing process. Furthermore, chemicals used in the embedding of antimicrobial material into the cover 1 may be selected to be safe for human contact.

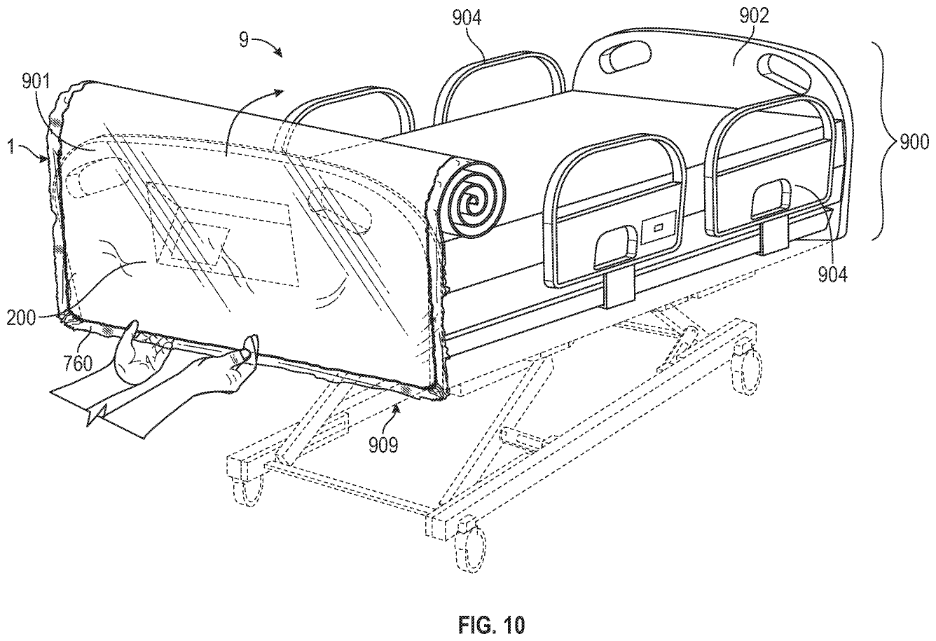

Referring to FIG. 10, the cover 1 may be easily fitted over the superstructure 900 without using tools. A user may apply a portion of the rim 760 of the cover 1 closest to a particular side or end surface of the cover 1 to a portion of the undersurface 909 closest to the corresponding hospital bed 9 structure. For example, the user may position the portion of the rim 760 closest to the front surface 200 of the cover 1 to the undersurface 909 closest to the foot board 901. The user may then spread the chosen side or end surface of the cover 1 out over the corresponding hospital bed 9 structure. For example, the user may spread the front surface 200 out over the foot board 901. The user may then spread the remaining surfaces of the cover 1 out over their corresponding hospital bed 9 structures, while being careful to prevent the outer material of the cover 1 from touching any contaminants. For example, the user may spread the left-side surface 400 and the right-side surface 500 out over their respective side rails 904; the user may also spread the rear surface 300 out over the head board 902; the user may then ensure the cover 1 is secured to the superstructure 900 of the bed 9 by applying the entire rim 760 around the perimeter of the undersurface 909.

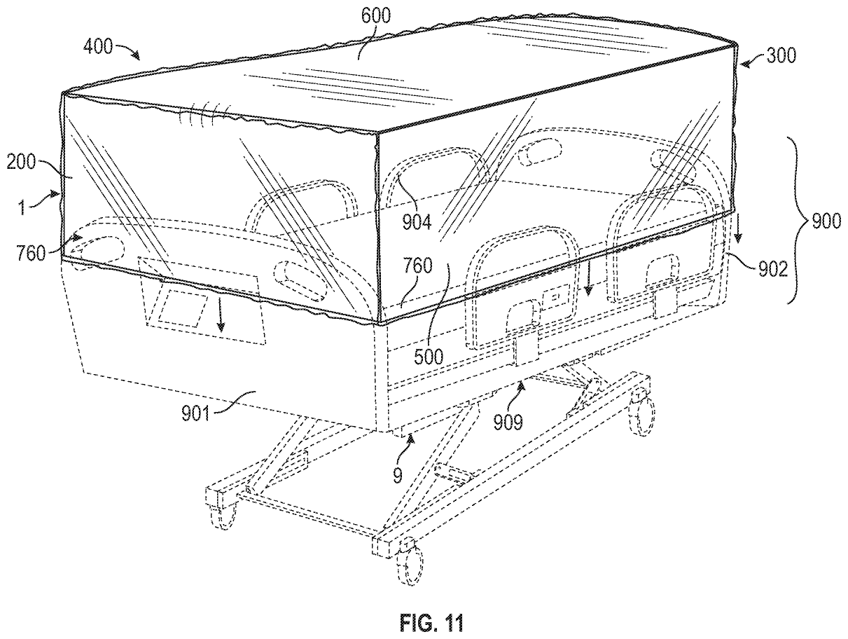

Referring to FIG. 11, a user may apply a portion of the rim 760 closest to a particular side or end surface of the cover 1 to an upper portion of the corresponding hospital bed 9 structure. For example, the user may apply a portion of the rim 760 closest to the front surface 200 of the cover 1 to an upper portion of the foot board 901. The user may then spread the remaining surfaces of the cover 1 out, while being careful to prevent the outer material of the cover 1 from touching any contaminants, and apply a portion of the rim 760 closest to a side or end surface of the cover 1 opposite to the previously chosen side or end surface of the cover 1 to its corresponding hospital bed 9 structure. For example, the user may apply a portion of the rim 760 closest to the rear surface 300 of the cover 1 to an upper portion of the head board 902. The user may then ensure the remaining rim 760 portions closest to the remaining surfaces of the cover 1 are aligned to fit over their respective hospital bed 9 structures and carefully slide the cover 1 down so that each respective surface of the cover 1 completely covers its corresponding hospital bed 9 structure. For example, the user may ensure the left-side surface 400 and the right-side surface 500 are aligned to fit over their respective side rails 904 and carefully slide the cover 1 down so that the front 200, rear 300, left-side 400, and right-side 500 surfaces each cover their respective hospital bed 9 structures and the top surface 600 comes to rest against the highest structure from the foot board 901, the head board 902, and a side rail 904 as measured from the undersurface 909 of the superstructure 900 to the top-most surface of the respective structure from the foot board 901, the head board 902, and a side rail 904.

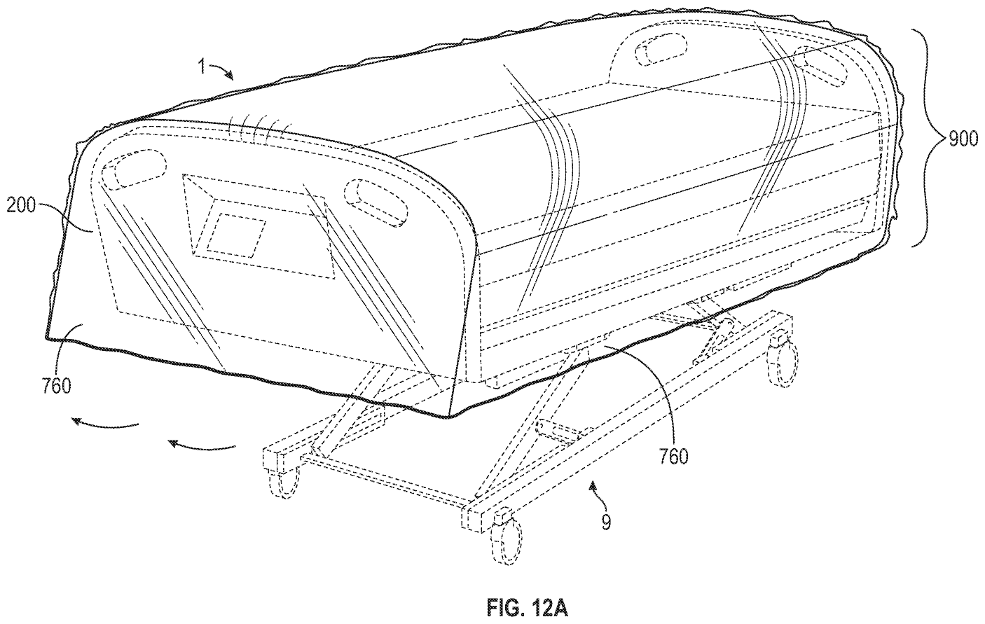

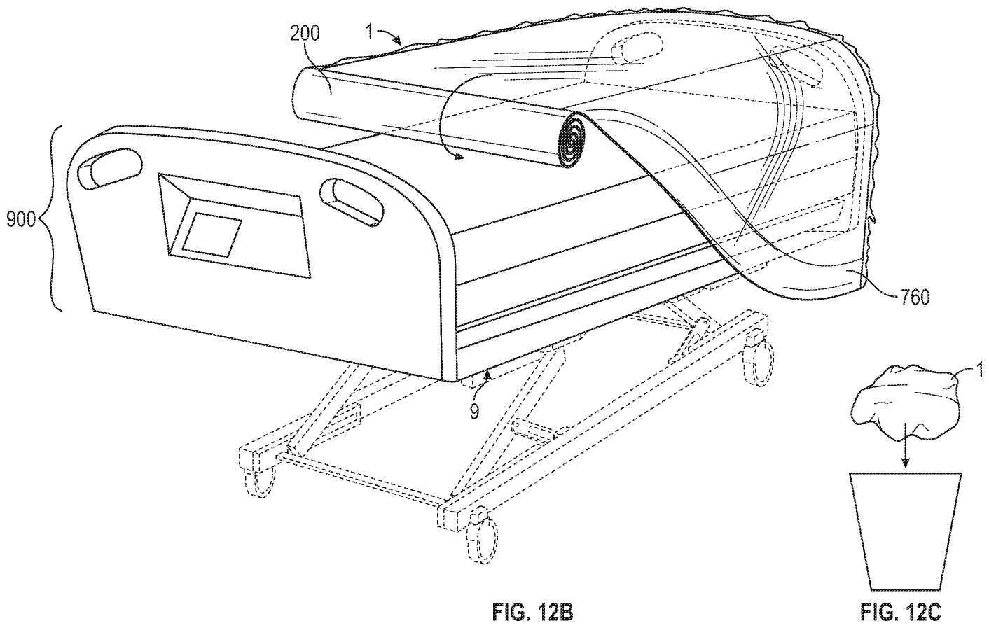

Referring to FIGS. 12A-12C, the cover 1 may be easily removed from the superstructure 900 without tools. Referring to FIGS. 12A-12B, when the cover 1 has been in use and in contact with or in close proximity to bodily fluids or other contaminants, the user may carefully remove the cover 1 from the bed 9 by gently pulling a portion of the rim 760 closest to a particular side or end surface of the cover 1 away from the superstructure 900 and furling (e.g., rolling up or folding up) the rim 760 into the inside of the particular side or end surface of the cover 1 so that any contaminants that may have touched the inner surface of the cover 1 remain on the inside of the rolled up cover 1. For example, the user may pull a portion of the rim 760 closest to the front surface 200 of the cover 1 away from the superstructure 900 and roll it into the front surface 200 of the cover. The user may then pull the remaining portions of the rim 760 closest to the remaining sides and end surfaces away from the superstructure 900, while being careful to prevent the outer material of the cover 1 from touching any contaminants, and furling the remaining portions of the rim 760 into the inside of their closest respective sides and end surfaces. Thereby, the user may ensure contaminants are not spilled or projected onto other surfaces intended to be kept clean and free from contamination.

Referring to FIG. 12C, once the cover 1 has been removed from the superstructure 900, the cover 1 can be disposed of by, for example, placing it in a waste basket specifically for medical waste. Because the cover 1 is composed of a thin, flexible plastic material, the cover 1 can be rolled up into, for example, a ball shape with the surface of the cover 1 that was in contact with contaminants facing inside the ball shape, thereby ensuring the user and/or others do not come into contact with the contaminants that may have transferred to the interior surface of the cover 1.

The cover 1 may be manufactured according to the following process. A raw polyethylene solution (e.g., a CPE solution) may be prepared and placed into a machine configured to blow a sheet of polyethylene into a large roll. A non-woven material may then be applied to the blown polyethylene material. The material may then be machine cut into sections having the individual cover dimensions. The gussets may then be made. The elastic may then be applied. The individual covers may then be wound into individual rolls, bound, and placed into product packaging with multiple covers per package.

While the present invention has been particularly shown and described with reference to some example embodiments thereof, it will be understood by those of ordinary skill in the art that various changes in form and details may be made therein without departing from the spirit and scope of the present invention as set forth in the following claims and their equivalents.

What is claimed is:

1. A medical furniture cover comprising:
a plurality of surfaces being formed of a thermoplastic material, the plurality of surfaces comprising an upper surface and a plurality of side surfaces integral with and extending from the upper surface, the upper and side surfaces being configured to cover corresponding surfaces of a medical furniture,
wherein two of the side surfaces are sized to fit a width and a height of the medical furniture,
wherein two others of the side surfaces are sized to fit a length and the height of the medical furniture,
wherein the upper surface is sized to fit the length and the width of the medical furniture,
wherein the cover has an opening opposite the upper surface for fitting the cover over the medical furniture, a periphery of the opening being formed by distal ends of the side surfaces, and
wherein an elastic band is attached to the cover and extends along the periphery of the opening for securing the cover to the medical furniture.

2. The cover of claim 1, wherein the medical furniture is a hospital bed or a gurney.

3. The cover of claim 1, wherein the thermoplastic material comprises polyethylene.

4. The cover of claim 3, wherein the thermoplastic material comprises chlorinated polyethylene.

5. The cover of claim 1, wherein the cover has a thickness in a range between 2 mils and 5 mils.

6. The cover of claim 1, wherein the cover further comprises a plurality of grommet holes fitted with grommets for securing the cover to the medical furniture.

7. The cover of claim 1, wherein the cover further comprises a plurality of gussets to form a squared profile for securing the cover to the medical furniture.

8. The cover of claim 1, wherein the cover has a color from among a color-coding scheme, and
wherein the color-coding scheme comprises at least two colors.

9. The cover of claim 1, wherein at least a portion of a surface from among the plurality of surfaces is transparent to allow a user to see a medical furniture control.

10. The cover of claim 9, wherein at least one side surface of the cover is sized to allow a user to access the medical furniture control without removing the cover.

11. The cover of claim 1, wherein the two of the side surfaces of the cover have substantially the same size.

12. The cover of claim 11, wherein the two others of the side surfaces of the cover have substantially the same size.

13. The cover of claim 1, wherein the cover is infused with an antimicrobial additive solution.

14. A system comprising:
a hospital bed or gurney comprising a superstructure and an undercarriage supporting the superstructure, the superstructure having a length, a width, and a height; and
a cover having an upper surface, a plurality of side surfaces integral with and extending from the upper surface, and an opening opposite the upper surface, a periphery of the opening being formed by distal ends of the side surfaces, the cover comprising an elastic band extending along the periphery of the opening,
wherein the cover has a length and a width greater than the length and the width of the superstructure such that the cover fits entirely around an upper and side surfaces of the superstructure.

15. The system of claim 14, wherein the superstructure comprises a deck, a mattress, a foot board, a head board, a plurality of side rails, and controls.

16. The system of claim 15, wherein the length and the width of the cover are respectively greater than a length and a width of the deck.

17. The system of claim 16, wherein a height of the cover is greater than a highest structure from the foot board, the head board, and the plurality of side rails such that the undercarriage extends through the opening in the cover.

18. The system of claim 16, wherein a height of the cover is greater than at least one structure from the foot board, the head board, and the plurality of side rails, and
wherein the periphery of the opening does not extend beyond a bottom edge of the superstructure.

19. The system of claim 14, wherein the cover is formed of a thermoplastic material.

20. A method of covering a medical furniture with a cover, the cover having an upper surface, a plurality of side surfaces integral with and extending from the upper surface, and an opening opposite the upper surface, a periphery of the opening being formed by distal ends of the side surfaces and having an elastic band extending along a periphery of the opening, the method comprising:
applying a portion of the periphery of the opening closest to one of the side surfaces of the cover around a portion of the medical furniture;
spreading the one of the side surfaces of the cover over the medical furniture;
spreading the upper surface and other ones of the side surfaces of the cover over a remainder of the medical furniture; and
securing an entirety of the periphery of the opening around a perimeter of the medical furniture.
